(19) United States
(12) Patent Application Publication
(10) Pub. No.: US 2013/0330559 A1
(43) Pub. Date: Dec. 12, 2013

(54) DOPING OF CARBON-BASED STRUCTURES FOR ELECTRODES

(71) Applicant: The Board of Trustees of the Leland Stanford Junior University, Palo Alto, CA (US)

(72) Inventors: Sondra Hellstrom, Stanford, CA (US); Michael Vosgueritchian, Redwood City, CA (US); Zhenan Bao, Stanford, CA (US); Myung-Gil Kim, Mountain View, CA (US)

(21) Appl. No.: 13/911,848

(22) Filed: Jun. 6, 2013

Related U.S. Application Data
(60) Provisional application No. 61/656,396, filed on Jun. 6, 2012.

(51) Int. Cl. H01B 1/18; H01B 13/30

(52) U.S. Cl. CPC H01B 1/18; H01B 13/30
USPC 428/408; 427/113

(57) ABSTRACT

Various aspects of the present disclosure are directed toward carbon-based electrodes. The carbon-based electrodes include a composition of carbon-based structures treated with an oxide material. The composition is annealed, including application of heat in excess of 200 degrees Celsius, which causes the reduction of the oxide material by electron transfer from the carbon-based structures. Additionally, the annealing facilitates stabilization and conductivity of the electrode.

Transparent electrodes are useful for touch screen, flat panel display and solar cell technologies. Carbon nanotube (CNT) networks and graphene thin films have recently been studied for these applications. While they show promise, as-deposited films still typically fall short of expectation. A transparent electrode can have a sheet resistance (R_{sq}) of at most 10 Ω/sq at 85% transmittance, and a good-quality, air-doped CNT network has a typical R_{sq} of about 200-300 Ω/sq at 85% transmittance. In the case of CNTs, low conductivities can be due to tube defects, low graphitization, or poorly dispersed films, but in general the presence of high junction resistances and Schottky barriers between metallic and semiconducting carbon nanotubes poses the biggest challenge.

### SUMMARY

Various example embodiments are directed apparatus, systems, and methods that are useful in providing transparent electrodes for touch screen, flat panel display and solar cell technologies.

Aspects of the present disclosure are directed toward methods of manufacturing carbon-based electrodes. The methods include treating carbon-based structures with an oxide material, and performing an annealing step. The anneal step includes application of heat, in excess of 200 degrees Celsius, which causes the reduction of the oxide material by electron transfer from the carbon-based structures. Additionally, the annealing facilitates stabilization and conductivity of the electrode.

Various aspects of the present disclosure are also directed toward carbon-based electrodes including an annealed network of carbon-based structures treated with an oxide, (the annealing facilitating stabilization and conductivity of the electrode).

Various aspects of the present disclosure are also directed toward methods having a step of providing a composition including carbon-based structures and an oxide-based material. The composition including work function interface having an initial work function interface susceptible to substantial degradation in an ambient steady-state condition. The methods also include performing an annealing step in which the composition is heated beyond a temperature at which the substantial degradation manifests in a degraded work function interface. Further, the methods include, after the step of annealing, providing the annealed composition with a work function interface having a work function interface that is closer to the initial work function and that is not susceptible to substantial degradation in the ambient steady-state condition.

Doping a carbon nanotube network can improve network conductivity in two ways. Firstly, doping can increase the free carrier concentration in the networks. Secondly, doping reduces the tube-tube junction resistance, as it allows carriers to pass more easily between metallic and semiconducting CNTs. CNTs are doped mildly p-type by oxygen adsorption, and while more severe partial chemical oxidation can serve a similar end, this process is difficult to control and is usually associated with the formation of considerable defects and loss of pi-conjugation and conductivity in the carbon nanotube.

There are a number of useful metrics to evaluate the performance of a transparent conductor, the most common being the DC to optical conductivity ratio. This convenient single-value figure of merit enables direct comparison of the qualities of a wide variety of transparent conductors at a wide variety of optical densities.

Dopants for carbon nanotubes range from alkali metals and halogens, to acidic liquid dopants such as chlorosulfonic acid, HNO₃, H₂SO₄, or SOCl₂, and redox dopants such as FeCl₃, AuCl₃,F4-TCNQ, triethyloxonium hexachloroantimonate₉ or bis(trifluoromethanesulfonyl)imide. Most of the results are unstable to air, chemicals, thermal stress, and/or humidity and also introduce mobile ions into the network, which can damage a device fabricated on top of the films. HNO₃ immersion, perhaps the most common CNT network doping method, typically generates networks with DC to optical conductivity ratios ranging from 7-40. Nevertheless, sheet resistances generally rise quickly after doping, reducing, for example, a film with a DC to optical conductivity of 40 to one with less than 20 in a matter of hours. AuCl₃ doped films have sheet conductances about 66% of their original doped value after 50 days and sheet conductances about 20% of their original doped value after heating to 200° C. Capping a doped film with PEDOT:PSS or sol-gel improves the doping stability in ambient air but can complicate processing, increase the film thickness and, in the latter case, make the CNT film difficult to address electrically.

Development of mild, stable, reliable, low toxicity doping is therefore desired for enabling carbon nanotube transparent electrode technology. Use of a nonvolatile metal chloride cation can improve the stability of a doped carbon nanotube network. However, strong acid treatment is necessary in addition to dopant application to achieve good performance, and the films still degrade, with sheet resistance suffering a 15% increase over 100 hours. Bis(trifluoromethanesulfonyl)imide also maintains nearly stable doping at room temperature. Nevertheless, very little ambient stability data, and no robust thermal (above 150° C. for at least several hours) and chemical stability data have been reported to date for doped CNT networks or for graphene. Demonstrated mechanisms to strongly and stably dope carbon nanotubes and graphene, and to control their functionalization, remain rare and highly desirable.

Molybdenum oxide and tungsten oxide are useful electronic materials, due to their ease of deposition from vapor or solution and their relatively accessible reduction and oxidation. The filling of trap states left by partial reduction of Mo(VI) oxide are usually accompanied by considerable changes in the absorption and conductivity of the material, which makes it useful for sensing or electrochromic applications. Molybdenum oxide and tungsten oxide are also evaporable or solution processable p-type dopants. Further, molybdenum oxide and tungsten oxide can have hole injection layers for wide band-gap organic semiconductors, typically in organic light-emitting diodes or photovoltaic cells.

Molybdenum oxide and tungsten oxide, however, have been considered to be weak dopants because induced hole densities per wt % MoOₓ have typically been low. Further, the stability of the doping effect in the presence of air and water has been questionable, especially as exposure to atmospheric oxygen is known to substantially degrade the work function of evaporated films of MoOₓ.

Surprisingly, it has been found that thermally annealed MoOx-CNT composites, MoOx-graphene composites, Tungsten Oxide-CNT composites, and Tungsten Oxide-graphene composites can form durable thin film electrodes, likely due to a charge-transfer interaction between the oxide and the organic networks (e.g., CNT, graphene). In this regard, stable p-doped bilayer transparent electrodes are provided. Unexpectedly, the interaction between the oxide and the organic network is enhanced by thermal activation, and the influence of annealing was assessed with the MoOₓ deposition method on the properties of these films.

Such composites can have, for example, sheet resistances of 100 Ω/sq at 85% transmittance plain and 85 Ω/sq at 83% transmittance with a PEDOT:PSS adlayer. Sheet resistances change less than 10% over 20 days in ambient air and less than 2% with overnight heating to 300° C. in air. The MoOx can be easily deposited either by thermal evaporation or from solution-based precursors. Excellent stability coupled with high conductivity makes MoOx-CNT composites extremely attractive candidates for practical transparent electrodes.

The above discussion is not intended to describe each embodiment or every implementation of the present disclosure. The figures and following description also exemplify various embodiments.

### BRIEF DESCRIPTION OF THE DRAWINGS

The disclosure may be more completely understood in consideration of the detailed description of various embodiments of the disclosure that follows in connection with the drawings, each being consistent with one or more of these embodiments, in which

FIG. 1 shows an example carbon-based electrode, consistent with various aspects of the present disclosure;

FIG. 2A shows sheet resistance as a function of transmittance for annealed MoOₓ-CNT composites, transmittance for unannealed MoOₓ-CNT composites shown, vs. as-deposited CNTs, consistent with various aspects of the present disclosure;

FIG. 2B shows transmittance spectra of MoOₓ-CNT bilayer networks relative to undoped CNT networks of similar thicknesses, consistent with various aspects of the present disclosure;

FIG. 2C shows transmittance spectra of a CNT network doped with 2,3,5,6-tetrafluoro-7,7,8,8-tetracyanoquinodimethane relative to an undoped CNT network of similar thickness, consistent with various aspects of the present disclosure;

FIG. 2D shows spectra as described in FIG. 2B converted to absorbance, with a fitted CNT baseline of k/λ subtracted to show details of CNT van Hove transitions, consistent with various aspects of the present disclosure;

FIG. 2E shows spectra as described in FIG. 2C converted to absorbance, with a fitted CNT baseline of k/λ subtracted to show details of CNT van Hove transitions, consistent with various aspects of the present disclosure;

FIG. 3A shows an example SEM micrograph of an annealed MoOₓ-CNT composite film, consistent with various aspects of the present disclosure;

FIG. 3B shows example Ramans spectra of a plain airbrushed CNT network, and of similar networks doped with F4-TCNQ and with heat-treated MoOₓ, consistent with various aspects of the present disclosure;

FIG. 4 shows example peaks for MoOₓ-CNT composites before and after annealing, compared with an untreated, airbrushed CNT network, consistent with various aspects of the present disclosure;

FIG. 5 shows example responses of MoOₓ-CNT and F4-TCNQ doped CNT samples to different thermal and chemical stressors, consistent with various aspects of the present disclosure;

FIG. 6 shows example energy levels of transition metal oxides, consistent with various aspects of the present disclosure;

FIG. 7A shows an example Raman spectra of transition of V₂O₅/swCNT, consistent with various aspects of the present disclosure;

FIG. 7B shows an example Raman spectra of transition of MoO₃/swCNT, consistent with various aspects of the present disclosure;

FIG. 7C shows an example Raman spectra of transition of WO₃/swCNT, consistent with various aspects of the present disclosure; and

FIG. 8 shows an example Raman spectra of transition V₂O₅/graphene composite, consistent with various aspects of the present disclosure.

While the disclosure is amenable to various modifications and alternative forms, specifics thereof have been shown by way of example in the drawings and are described in detail herein (and including in the Appendices filed in the underlying provisional application). It should be understood that the intention is not to necessarily limit the disclosure to the particular embodiments described. On the contrary, the intention is to cover all modifications, equivalents, and alternatives falling within the spirit and scope of the disclosure.

### DETAILED DESCRIPTION

The present disclosure is related to methods and apparatuses directed toward providing transparent electrodes for touch screen, flat panel display and solar cell including methods and devices in and stemming from the disclosures in the above-referenced patent documents to which benefit is claimed.

Aspects of the instant disclosure are directed towards methods of manufacturing carbon-based electrodes, as well as the apparatuses and systems that result therefrom. For example, certain embodiments of methods of manufacturing carbon-based electrodes include treating carbon-based structure(s) (e.g., carbon nanotubes, graphene structures) with an oxide material (e.g., Tungsten Oxide, Molybdenum Oxide, vanadium oxide, nickel oxide, copper oxide, and rhenium oxides). The oxide material can be a mixture of one or several oxides or it can be a complex oxide. Subsequently, an annealing step is performed, which includes the application of heat in excess of 200° Celsius (e.g., 150° C.-1000° C.). This annealing step causes the reduction of the oxide material by electron transfer from the carbon-based structure(s), and facilitates stabilization and conductivity of the electrode. In certain specific embodiments, the degree of treating the carbon-based nanostructure(s) with an oxide material is defined by the work function of the oxide prior to performing the annealing step. Certain more specific embodiments are further characterized in that the degree of treating is defined by the electrons transferred from the carbon-based structure(s) to the oxide after performing the annealing step. In other embodiments, treating carbon-based structure(s) with an oxide material includes applying the oxide material via thermal evaporation; sputtering; atomic layer deposition (ALD); or chemical vapor deposition (CVD). Other embodiments include air-brushing an oxide nanoparticle or precursor of the oxide material on the carbon-based structure(s) in the step of treating the carbon-based structure(s). Additionally, precursors can be solution deposited, such as air-brushed or spin coated.

Additionally, the annealing step can activate the oxide material such that there is an electron transfer from the carbon-based structure(s) to the oxide material which results in a reduction of the oxide material. Additionally, in certain embodiments, the annealing step results in a shift of an oxidation state of the oxide material due to the chemical reduction of the oxide material and receipt of electrons from the carbon-based structure(s). Further, the treating of the carbon-based structure(s) with the oxide material can include vacuum depositing the oxide material on the carbon-based structure(s). In certain embodiments, the treating includes applying the oxide material at a thickness of 10 nm, and in other embodiments, the oxide material and the carbon-based structure(s) are capped with a layer of PEDOT:PSS (Poly(3,4-ethylenedioxythiophene)poly(styrenesulfonate)) or sol-gel.

Aspects of the instant disclosure are also directed towards apparatuses. Some apparatuses include a carbon-based electrode having an annealed network of carbon-based structure(s) (e.g., carbon nanotubes, graphene structures) treated with an oxide material (e.g., Tungsten Oxide, Molybdenum Oxide, vanadium oxide, nickel oxide, copper oxide, and rhenium oxides), wherein the annealing facilitates stabilization and conductivity of the electrode. The carbon-based electrodes, consistent with aspects of the instant disclosure can include a layer of PEDOT:PSS (Poly(3,4-ethylenedioxythiophene)poly(styrenesulfonate)) or sol-gel that caps the oxide material and the network of carbon-based structure(s).

The instant disclosure also includes methods of manufacturing carbon-based electrodes that include treating carbon-based structure(s) (e.g., carbon nanotubes, graphene structures) with an oxide-precursor material (e.g., peroxy molybdic acids; peroxy tungstic acid). An annealing step, including application of heat in excess of 200° Celsius, is performed which causes the reduction of the oxide material by electron transfer from the carbon-based structure(s), wherein the annealing facilitates stabilization and conductivity of the electrode. In certain embodiments, treating carbon-based structure(s) with an oxide-precusor material includes air-brushing the oxide-precusor material on the carbon-based structure(s).

Additional aspects of the instant disclosure include carbon-based electrode apparatuses having an annealed network of carbon-based structure(s) treated with an oxide-precursor material (e.g., peroxy molybdic acids; peroxy tungstic acid), wherein the annealing facilitates stabilization and conductivity of the electrode.

Also included in the instant disclosure, are methods of manufacturing carbon-based electrodes that include depositing carbon-based structure(s) on an oxide-precursor material. A step of annealing is performed, which causes the reduction of the oxide-precursor material by electron transfer from the carbon-based structure(s), wherein the annealing facilitates stabilization and conductivity of the electrode. Other embodiments of the instant disclosure include methods of manufacturing carbon-based electrodes by depositing carbon-based structure(s) on an oxide material, and performing an annealing step causing the reduction of the oxide material by electron transfer from the carbon-based structure(s), wherein the annealing facilitates stabilization and conductivity of the electrode. Further, the methods can also include annealing an oxide material in excess of 200° Celsius, and subsequently depositing carbon-based structure(s) on the annealed oxide material. This combination causes the reduction of the oxide material by electron transfer from the carbon-based structure(s), and a stable and conductive electrode.

Aspects of the instant disclosure are also directed towards a composition of carbon-based structures and an oxide material (which can include an oxide precursor such as peroxy molybdic acids and peroxy tungstic acid). In such embodiments, the oxide-based material is a material which, when annealed with the carbon-based structure(s), includes an annealed work function interface that is stable (e.g., not susceptible to substantial degradation) in a steady-state ambient environment.

The instant disclosure also includes methods that involve providing a composition that includes carbon-based structure(s) and an oxide-based material (which can include an oxide precursor such as peroxy molybdic acids and peroxy tungstic acid). The composition has a work function interface with an initial work function interface susceptible to substantial degradation in an ambient steady-state condition. A step of annealing is performed in which the composition is heated beyond a temperature at which the substantial degradation manifests in a degraded work function interface. After the step of annealing, the annealed composition is provided with a work function interface having a work function interface that is closer to the initial work function and that is not susceptible to substantial degradation in the ambient steady-state condition.

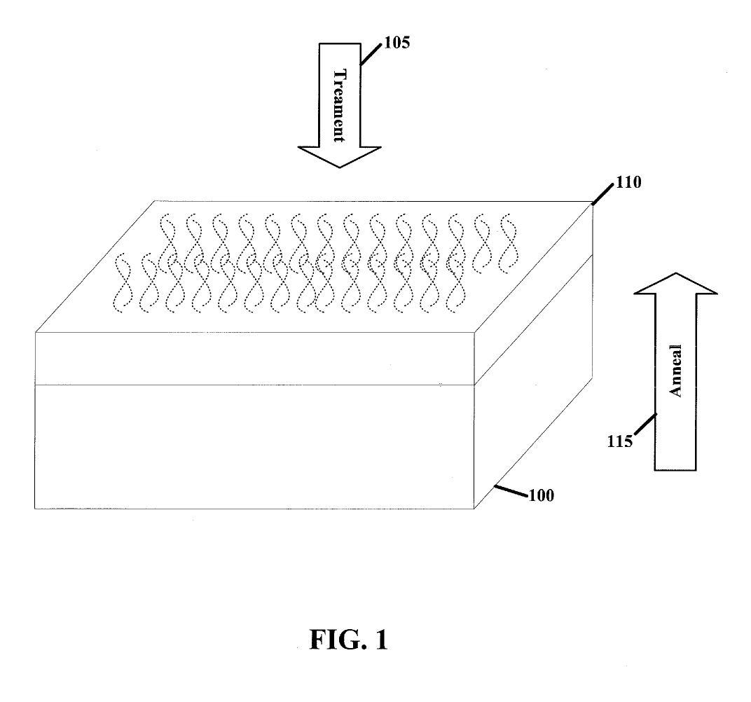

Turning now to the figures, FIG. 1 shows an example carbon-based electrode, consistent with various aspects of the present disclosure. FIG. 1 shows an example carbon-based electrode as is provided on a substrate 100. The carbon based electrode is provided by treating 105 carbon-based structures (e.g., carbon nanotubes, graphene structures) with an oxide material (e.g., Tungsten Oxide, Molybdenum Oxide, vanadium oxide, nickel oxide, copper oxide, and rhenium oxides) to provide a composition 110 of the carbon-based structures and the oxide material. The oxide material can be a mixture of one or several oxides or it can be a complex oxide. Subsequently, an annealing step is performed 115, which can include the application of heat in excess of 200° Celsius (e.g., 150° C.-1000° C.). This annealing step causes the reduction of the oxide material by electron transfer from the carbon-based structures, and facilitates stabilization and conductivity of the electrode.

In certain specific embodiments, the degree of treating 105 the carbon-based nanostructures with an oxide material is defined by the work function of the oxide prior to performing the annealing step 115. Additionally, in other embodiments, the degree of treating 105 is defined by the electrons transferred from the carbon-based structures to the oxide after performing the annealing step 115. In other embodiments, treating carbon-based structures 105 with an oxide material includes applying the oxide material via thermal evaporation; sputtering; atomic layer deposition (ALD); or chemical vapor deposition (CVD). Further, an oxide nanoparticle or precursor of the oxide material can be air-brushed on the carbon-based structures in the step of treating the carbon-based structures 105. Additionally, precursors can be solution deposited, such as air-brushed or spin coated.

### MORE DETAILED AND/OR EXPERIMENTAL EMBODIMENTS

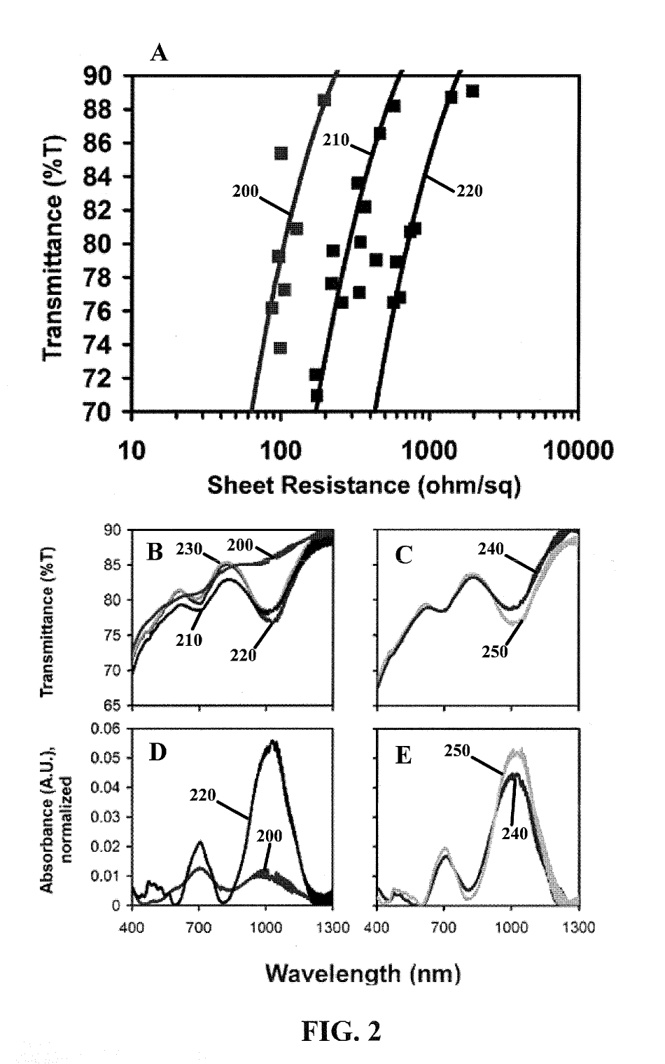

When a CNT network was airbrushed onto a glass surface in this work, the DC to optical conductivity ratio was found to range from 1.6-3.5, with an average of about 2.6. When airbrushed onto a vacuum-evaporated MoOₓ surface on borosilicate glass or SiO₂, it ranged from 4-7, with an average of about 5.6. As deposited, the presence of the MoOₓ already decreased network R_{sq} by about a factor of two. When annealed at 450-500° C. for 3 hours in argon, the bilayer performance improved further, for an overall decrease in R_{sq} by a factor of 5-7 relative to an undoped, unannealed network. The final DC to optical conductivity ratios averaged about 15, but could be as high as 23, or 24 if capped with PEDOT:PSS. The improvement is illustrated in FIG. 2A, showing data for R_{sq} vs. transmittance of airbrushed CNT networks of various thicknesses, and the same after deposition and annealing on a glass surface modified with MoOₓ.

FIG. 2A shows sheet resistance as a function of transmittance for annealed MoOₓ-CNT composites, transmittance for unannealed MoOₓ-CNT composites shown, vs. as-deposited CNTs, consistent with various aspects of the present disclosure. FIG. 2A shows sheet resistance as a function of transmittance for annealed MoOₓ-CNT composites (200), transmittance for unannealed MoOₓ-CNT composites (210), and as-deposited CNTs (220).

FIG. 2B shows transmittance spectra of MoOₓ-CNT bilayer networks relative to undoped CNT networks of similar thicknesses, consistent with various aspects of the present disclosure. For instance, FIG. 2B shows the transmittance spectra for annealed MoOₓ-CNT composites (200), transmittance for unannealed MoOₓ-CNT composites (210), as-deposited CNTs (220), and plain annealed CNTs (230).

FIG. 2C shows transmittance spectra of a CNT network doped with 2,3,5,6-tetrafluoro-7,7,8,8-tetracyanoquinodimethane (F4-TCNQ) relative to an undoped CNT network of similar thickness, consistent with various aspects of the present disclosure. FIG. 2C shows transmittance spectra of a F4-TCNQ treated CNT network (240) and an undoped CNT network (250).

FIG. 2D shows spectra as described in FIG. 2B converted to absorbance, with a fitted CNT baseline of k/λ subtracted to show details of CNT van Hove transitions, and FIG. 2E shows spectra as described in FIG. 2C converted to absorbance, with a fitted CNT baseline of k/λ subtracted to show details of CNT van Hove transitions, consistent with various aspects of the present disclosure. FIG. 2D shows converted absorbance spectra for annealed MoOₓ-CNT composites (200) and as-deposited CNTs (220). FIG. 2E shows converted absorbance spectra for a F4-TCNQ treated CNT network (240) and an undoped CNT network (250).

By comparison, MoOₓ films of identical thickness on glass or SiO₂ without CNTs in all cases had sheet resistances of more than 120 MΩ both before and after annealing. Annealing an analogous CNT network without MoOₓ resulted in R_{sq} improvement of 1.2-1.7, confirming that the observed effect was due to MoOₓ-CNT interaction. For comparison, doping a CNT network with F4-TCNQ on glass led to only about a 1.3-1.5-fold decrease in R_{sq} for DC to optical conductivity ratios in the range of 3-4. MoOₓ-CNT bilayer composites, especially after annealing, were thus notably superior to undoped and F4-TCNQ doped CNT networks.

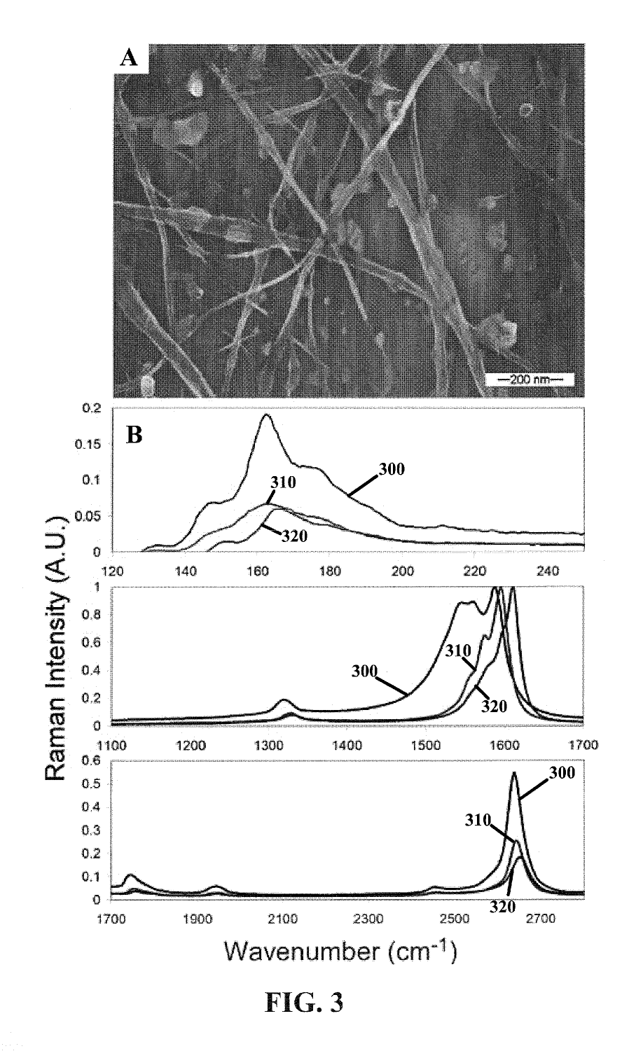

MoOₓ films of less than, e.g., 10 nm thickness were essentially transparent in the visible as initially deposited from vacuum. Scanning electron microscopy images (FIG. 3A) showed that after annealing, the MoOₓ layer dewetted from glass supporting substrates and did not remain continuous. Plain MoOₓ thin films displayed a broad and rather variable absorbance in the 600-1250 nm range, indicative of the presence of slightly nonstochiometric oxide. Annealing MoOₓ in vacuum or an inert environment can cause oxygen deficiency and the formation of electron traps. Some of the electrons in these traps can be photoexcited into the MoOₓ valence band, resulting in broad and widely variable low-wavelength absorbance and the increasing coloration of the MoOₓ from light green to deep blue.

Absorbance data after annealing in the presence of a CNT adlayer is less variable. Transmittance of a representative annealed MoOₓ-CNT bilayer film is shown in FIG. 2B, with details of normalized absorption spectra shown in FIG. 2C. The data resembles a typical CNT network spectrum with suppressed van Hove transitions overlaid on top of a broad spectrum of MoO₃₋ₓ. If the deposited MoOₓ layer was thin enough, and the CNT network was dense enough, the absorbance of the film was dominated by CNTs, which was a condition for the fabrication of high-quality transparent conductors. Practically, this condition can be achieved reliably with evaporated MoOₓ films of less than 10 nm thickness and airbrushed CNT networks with transmittances of 75-90% before annealing.

Suppression of the van Hove transitions is consistent with strongly doped CNTs. Compared to airdoped CNT networks on glass, unannealed networks on MoOₓ showed evidence of a small amount of charge transfer, and annealed networks had a larger response. With doping, the area attributable to the sE₂₂ CNT transitions decreased by roughly 10% for F4-TCNQ and 64% for annealed MoOₓ.

For high-transmittance composites, the MoOₓ layer was very thin, and in these composites no observable Raman signals could be attributed to MoOₓ modes. Raman spectroscopy of F4-TCNQ and MoOₓ doped composites at 633 nm excitation wavelength revealed the relative suppression of RBM and G-band intensity in the CNTs compared with the CNT G-band. Additionally, the CNT G-band both substantially narrowed and shifted towards longer wave numbers, which is consistent with substantial charge withdrawal from the CNTs. For F4-TCNQ, the G-band shifted by about 2 cm⁻¹ to 1597 cm⁻¹ compared to an as-deposited film. CNTs airbrushed onto MoOₓ before any heat treatment had G-bands 3-5 cm⁻¹ higher in wave number than those sprayed onto plain glass in the same experiment. After heat treatment, this shift increased to 14-17 cm⁻¹, or to 1609-1611 cm⁻¹.

The amount of Raman G-band upshift for a particular semiconducting CNT and excitation wavelength is known theoretically and experimentally to directly depend on the amount of charge removed per carbon atom; greater shift implies more charge withdrawn, although not linearly. Chemical or electrochemical experimental doping exhibited a maximum Raman shift of about 10-15 cm⁻¹ at 633 nm excitation, corresponding to movement of the Fermi level below the second semiconducting CNT transition. Suppression of the sE₂₂ in the absorption spectra of annealed MoOₓ-CNT films is observed, indicating that for many tubes in these networks, a level of degenerate doping has been reached.

It may be understood from the optical and Raman spectroscopy that, before annealing, considerable charge transfer from MoOₓ to a CNT adlayer took place. However, annealing the bilayer in an inert environment to temperatures of 450-500° C. conferred great advantage both in terms of film robustness and in a much more significant degree of charge transfer from the CNTs. Heating the bilayer drove the partial oxidation of the CNTs and the partial reduction of MoO₃ much further than did simple deposition of CNTs onto the supported MoOₓ surface. The activation of the MoOₓ towards chemical oxidation of nanocarbon occurred optimally around 450° C.

This activation was observed via ultraviolet photoelectron spectroscopy. After deposition of 55 Å of MoOₓ in UHV onto an indium tin oxide substrate its work function (WF) was measured to be 6.82 eV. The MoOₓ film was then exposed to air for one hour. This enormously reduced the surface WF to 5.64 eV, 1.18 eV lower than the initially evaporated MoOₓ film. After the exposure, the MoOₓ film was reintroduced into the UHV measurement chamber, with a base pressure of 8×10⁻¹¹ torr, and gradually annealed. At 375° C., 410° C. and 460° C., the WFs were measured to be 6.09 eV, 6.28 eV, and 6.36 eV, respectively. At 460° C., the WF recovery saturated and did not change further with increasing annealing temperature. The final WF observed at 460° C. was over 6.3 eV, slightly more than 60% of the initial value.

The most typical work functions of carbon nanotubes are about 4.7 eV, but a wide range exists, from 4.4 up to 5.95 eV for certain CNTs. The first van Hove peaks in semiconducting CNTs lie about 0.26-0.8 eV below the Fermi level, and the second about 0.5-1.5 eV below the Fermi level. Van Hove transitions in metallic tubes are somewhat less than 1 eV below the Fermi level. The doping data and the UPS data agree very well. The lower work function of about 5.6 eV for air-exposed MoOₓ was sufficient to withdraw charge from sE₁₁ in many of the nanotubes in the network; spontaneous charge transfer from the CNTs still took place. When air-exposed MoOₓ was annealed past about 450° C. in an oxygen-poor environment, it became a much stronger reducing agent, and then in many cases was capable of shifting the Fermi level of the CNTs in the network even past sE₂₂ and mE₁₁.

FIG. 3A shows an example SEM micrograph of an annealed MoOₓ-CNT composite film, consistent with various aspects of the present disclosure. FIG. 3B shows example Raman spectra of a plain airbrushed CNT network, and of similar networks doped with F4-TCNQ and with heat-treated MoOₓ, consistent with various aspects of the present disclosure. FIG. 3B shows a plain airbrushed CNT network (300), a F4-TCNQ doped network (310), and a heat-treated MoOₓ network (320).

X-ray photoelectron spectroscopy also provided insight into the mechanism of interaction between the MoOₓ and the CNTs and into its stability. As shown in FIG. 3, in spite of a small amount of coloration in the MoOₓ film, the Mo⁶⁺ oxidation state dominated the Mo 3d spectrum, while the Mo⁴⁺ oxidation state was absent before annealing. After annealing, while Mo⁶⁺ was still the dominant species, Mo⁴⁺ and intermediate oxidation states became visible. This is evidence for the chemical reduction of MoOₓ, i.e., the receipt of electrons from the CNTs. In addition, no strong evidence of Mo—C bonding was observed in Mo 3d spectrum after annealing.

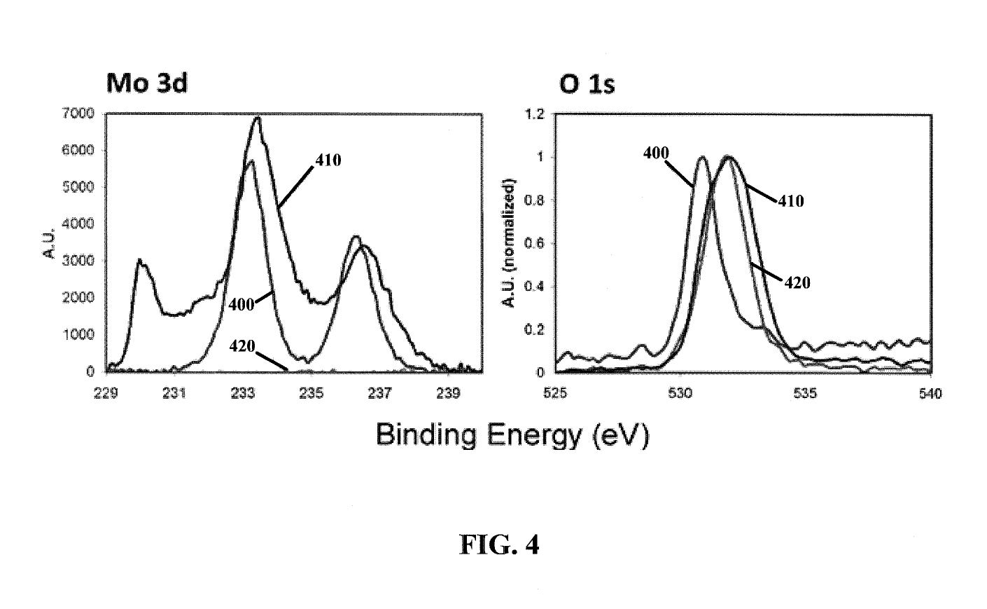

FIG. 4 shows example peaks for MoOₓ-CNT composites before (400) and after annealing (410), compared with an untreated, airbrushed CNT network (420), consistent with various aspects of the present disclosure. Also as shown in FIG. 4 is a shift in the oxygen 1s peak (right graph) away from the characteristic binding energy of MoOₓ and towards the binding energy of adsorbed oxygen/moisture species or carbon-oxygen bonds. The binding energy of oxygen in MoO₃ is around 530 eV, whereas the binding energy of adsorbed oxygen or carbon-oxygen bonds is around 532-533 eV. This substantial shift in the oxygen is peak towards higher binding energy species is another piece of evidence for oxygen associated doping of CNTs at the expense of lattice oxygen in the MoOₓ. The stability of the resulting charge transfer has to do with the nonvolatile nature of the metal oxides, and with the permanence of the chemical changes induced by higher temperatures, even when the composite is subject to air or chemical exposure or thermal stress.

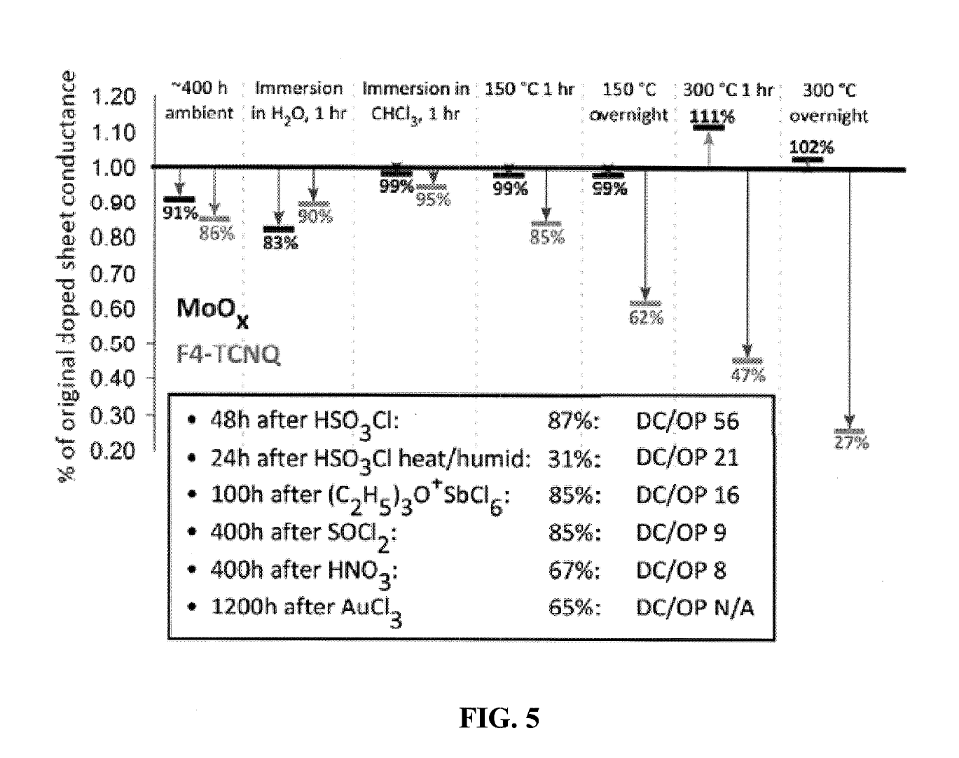

FIG. 5 shows example responses of MoOₓ-CNT and F4-TCNQ doped CNT samples to different thermal and chemical stressors, consistent with various aspects of the present disclosure. FIG. 5 shows the relative impact of various stressors on the sheet resistance of MoOₓ-CNT bilayer films, compared with similar data on CNT films that have been doped with F4-TCNQ, and to alternative dopants in the literature. MoOₓ is the most stable, strong CNT dopant currently available. In ambient conditions over 20 days, sheet resistances changed, on average, less than 10%. MoOₓ-CNT composites had superior chemical stability over F4-TCNQ doped samples subject to every chemical test performed except for 1 hr. immersion in water. This instability is most likely due to the small but notable solubility of MoOₓ in water.

MoOₓ-CNT composites are particularly valuable transparent conductors for applications that require thermal stability. Surprisingly and unlike previously reported dopants, they maintained low sheet resistances even up to overnight heating in ambient at 300° C. The sheet resistances of unannealed samples improved when subject to temperatures in the range 400-500° C. in an inert environment. After the first annealing, MoOₓ-CNT bilayers could sustain reheating to the same temperature in an inert environment for at least three hours, with negligible change in sheet resistances. In air, the thermal stability limit was the temperature at which CNTs themselves oxidize, which is about 390° C. The exceptional thermal stability can be attributed to the non-volatility of supported MoOₓ below this temperature.

The process of MoOₓ-doping as reported in this work is extensible both to other methods of depositing MoOₓ and to other materials such as graphene. A difficult aspect of achieving entirely solution-processed MoOₓ-CNT transparent electrodes is in fabrication of a sufficiently thin and uniform film of MoOₓ. By synthesizing a peroxy poly molybdic acid precursor and by airbrushing or spin-coating this precursor onto glass substrates prior to CNT deposition and annealing, highly doped CNT networks are achieved, with strongly suppressed sE₂₂ van Hove transitions and Raman G-bands above 1608 cm⁻¹. An entirely solution-deposited transparent conductor can be fabricated with sheet resistance of 120 Ω/sq at 76% transmittance, corresponding to a DC to optical conductivity ratio of 10.5. With continued optimization of precursor deposition, equivalent results can be achieved with airbrushed and vacuum deposited MoOₓ.

Further, by evaporating MoOₓ on top of single-layer graphene grown by chemical vapor deposition and transferred to a SiO₂ substrate, sheet resistance improvements of a factor of 1.7 can be achieved, corresponding to an initial sheet resistance of 465 Ω/sq and a final sheet resistance of 270 Ω/sq. This improvement of about 40% is comparable with the initial effects of unstable strong acid doping on graphene films.

Stably and strongly doping CNTs and graphene using MoOₓ or tungsten oxide produces a nontoxic, inexpensive, vacuum or solution deposited electrode (as opposed to using strong liquid acids). Transparent conductors with DC to optical conductivity ratios of as high as 23 are fabricated as a result. Annealing to 450° C. can substantially activate this dopant and encourage the charge transfer from CNTs or graphene to the oxide, and because of this activation behavior, the composites exhibit stable sheet conductances even for extended periods under ambient conditions or at elevated temperatures.

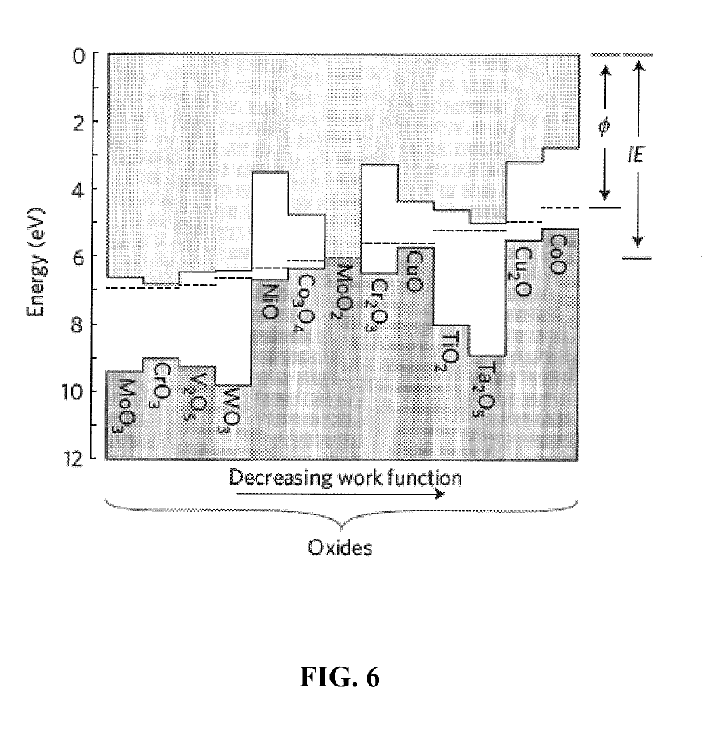

FIG. 6 shows example energy levels of transition metal oxides, consistent with various aspects of the present disclosure. In addition to the success of MoO₃ as a stable and strong oxide dopant, there is wide range of other choices as a possible charge transfer dopant. As shown in FIG. 6, considering band structures of transition metal oxides, V₂O₅, CrO₃, and WO₃ are also candidates for use as a stable and strong oxide dopant.

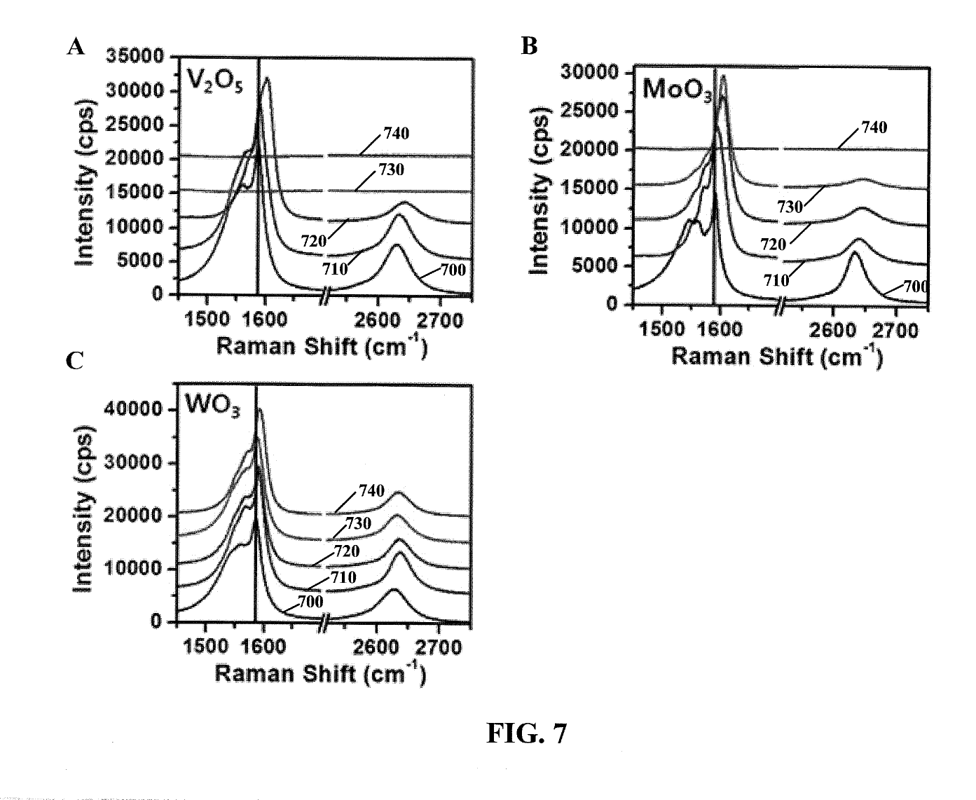

Among the various candidates identified in FIG. 6, V₂O₅ and WO₃ were demonstrated as additional oxide dopants system. For instance, FIG. 7A shows an example Raman spectra of transition of V₂O₅/swCNT, FIG. 7B shows an example Raman spectra of transition of MoO₃/swCNT, and FIG. 7C shows an example Raman spectra of transition of WO₃/swCNT, consistent with various aspects of the present disclosure. The V₂O₅ and WO₃ were thermally evaporated over the spray coated swCNT mixture. The V₂O₅/CNT composite showed promising results with a thermal activation temperature of ˜400° C. The significant G-peak shift (˜1600 cm¹) in FIG. 7A is comparable to that of MoO₃/swCNT composite in FIG. 7B. In comparison, the WO₃ shows thermally robust nature with less obvious G-peak shift, as shown in FIG. 7C. The relatively small size cation oxide seems like activated and oxidized swCNT at a lower temperature. Each of FIGS. 7A-C show Raman spectra for a network of only CNTs (700) as compared to doped, with the respective oxide of FIGS. 7A-C, CNTs that have been annealed at different temperatures. FIGS. 7A-C show Raman spectra as annealed at 300° C. (710), 400° C. (720), 500° C. (730), and 600° C. (740).

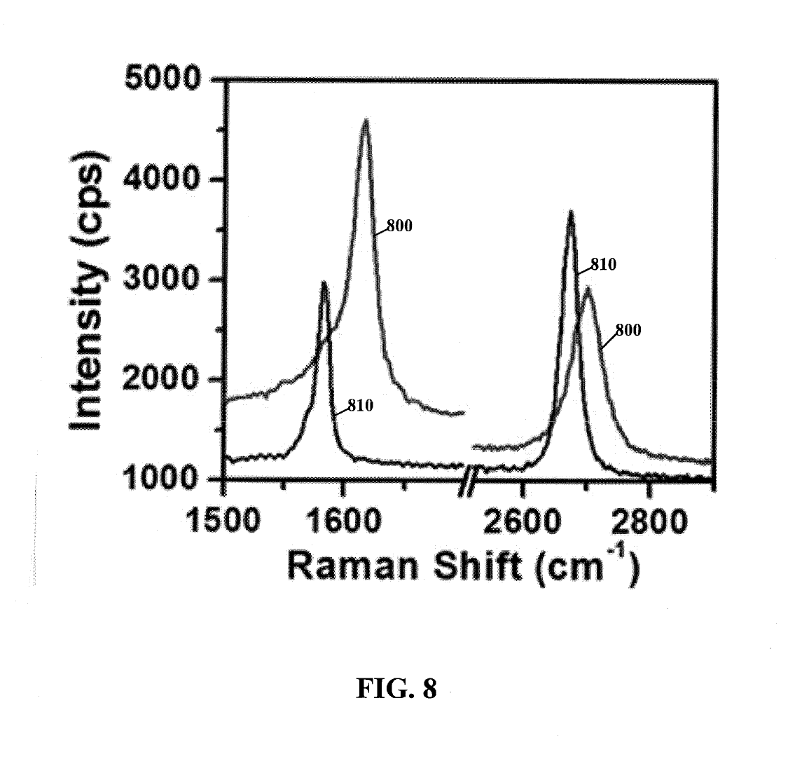

FIG. 8 shows an example Raman spectra of transition V₂O₅/graphene composite, consistent with various aspects of the present disclosure. FIG. 8 shows an example Raman spectra of transition V₂O₅/graphene composite (800) as compared to only pristine graphene (810). As shown in FIG. 8, thermally evaporated V₂O₅ on top of graphene can provide significant doping and improved conductivity above ˜2 times even without annealing. The significant Raman G-peak shift from 1583 cm⁻¹ to 1616 cm⁻¹ was observed.

While the present disclosure is amenable to various modifications and alternative forms, specifics thereof have been shown by way of example in the drawings and will be described in further detail. It should be understood that the intention is not to limit the disclosure to the particular embodiments and/or applications described. On the contrary, the intention is to cover all modifications, equivalents, and alternatives falling within the spirit and scope of the present disclosure.

The embodiments and specific applications discussed herein and in the above-referenced patent applications (including the Appendices therein) to which priority is claimed, may be implemented in connection with one or more of the aspects, embodiments and implementations described herein, as well as with those shown in the figures. One or more of the items depicted in the present disclosure and in the Appendices can also be implemented in a more separated or integrated manner, or removed and/or rendered as inoperable in certain cases, as is useful in accordance with particular applications. For general information regarding carbon structure doping, and for specific information regarding carbon structure doping with oxides and approaches to which one or more embodiments may be directed, reference may be made to Lanfei Xie, Xiao Wang, Hongying Mao, Rui Wang, Mianzhi Ding et al., “Electrical measurement of non-destructively p-type doped graphene using molybdenum trioxide,” Appl. Phys. Lett. 99, Issue 1 (2011); Meyer, J., Khalandovsky, R., Goan, P. and Kahn, A. “MoO₃ Films Spin-Coated from a Nanoparticle Suspension for Efficient Hole-Injection in Organic Electronics,” Adv. Mater., 23: 70-73, (2011); Vasilopoulou, Maria et al., “High performance organic light emitting diodes using substoichiometric tungsten oxide as efficient hole injection layer,” Organic Electronics 13, 796 (2012); Chen, Zhenyu et al., “Surface transfer hole doping of epitaxial graphene using MoO₃ thin film,” Appl. Phys. Lett. 96, Issue 21 (2010); Marisic, Milton M., “Heteropoly-acids as Catalysts for the Vapor Phase Partial Oxidation of Naphthalene,” J. Am. Chem. Soc., 1940, 62 (9), pp 2312-2317; and the Provisional Application Ser. No. 61/656,396 filed on Jun. 6, 2012, to which this application claims benefit, which is fully incorporated herein by reference for related teachings. In view of the description herein, those skilled in the art will recognize that many changes may be made thereto without departing from the spirit and scope of the present invention.

What is claimed is:

1. A method of manufacturing carbon-based electrodes, comprising:
treating carbon-based structures with an oxide material; and
performing an annealing step, including application of heat, in excess of 200 degrees Celsius, which causes reduction of the oxide material by electron transfer from the carbon-based structures, wherein the annealing facilitates stabilization and conductivity of the electrode.

2. The method of claim 1, wherein the degree of treating is defined by a work function of the oxide prior to performing the annealing step.

3. The method of claim 2, wherein the degree of treating is defined by the electron transferred from the carbon-based structures to the oxide after performing the annealing step, the carbon-based structures are at least one of carbon nanotubes and graphene structures, and the oxide material is at least one of Tungsten oxide, Molybdenum oxide, vanadium oxide, nickel oxide, copper oxide, and rhenium oxides.

4. The method of claim 1, wherein the application of heat includes heating at a temperature between 150 degrees C. and 1000 degrees C.

5. The method of claim 1, wherein treating carbon-based structures with an oxide material includes applying the oxide material via at least one of thermal evaporation; sputtering; atomic layer deposition (ALD); and chemical vapor deposition (CVD).

6. The method of claim 1, wherein treating carbon-based structures with the oxide material includes air-brushing an oxide nanoparticle or precursor of the oxide material on the carbon-based structures.

7. The method of claim 1, wherein the annealing step activates the oxide material towards electron transfer from the carbon-based structures to the oxide material which results in a reduction of the oxide material.

8. The method of claim 1, wherein treating carbon-based structures with oxide material includes vacuum depositing the oxide material to the carbon-based structures.

9. The method of claim 1, wherein treating carbon-based structures with oxide material includes applying the oxide material at a thickness of 10 nm.

10. The method of claim 1, wherein the annealing step shifts an oxidation state of the oxide material due to the reduction of the oxide material and receipt of electrons from the carbon-based structures.

11. The method of claim 1, further including a step of capping the oxide material and the carbon-based structures with a layer of at least one of PEDOT:PSS (Poly(3,4-ethylenedioxythiophene)poly(styrenesulfonate)) and sol-gel.

12. A carbon-based electrode apparatus comprising:
an annealed network of carbon-based structures treated with an oxide material, wherein the annealing facilitates stabilization and conductivity of the electrode.

13. The apparatus of claim 12, further including a layer of PEDOT:PSS (Poly(3,4-ethylenedioxythiophene)poly(styrenesulfonate)) or sol-gel capping the oxide material and the network of carbon-based structure(s).

14. The apparatus of claim 12, wherein the carbon-based structures are at least one of carbon nanotubes and graphene structures, and the oxide material is at least one of Tungsten oxide, Molybdenum oxide, vanadium oxide, nickel oxide, copper oxide, and rhenium oxides.

15. The apparatus of claim 12, wherein the annealed network of carbon-based structures includes carbon nanotubes treated with an oxide material that includes Tungsten oxide.

16. The apparatus of claim 12, wherein the annealed network of carbon-based structures includes graphene structures treated with an oxide material that includes Molybdenum oxide.

17. A method comprising:
providing a composition including carbon-based structures and an oxide-based material, the composition including work function interface having an initial work function interface susceptible to substantial degradation in an ambient steady-state condition;
performing an annealing step in which the composition is heated beyond a temperature at which the substantial degradation manifests in a degraded work function interface; and
after the step of annealing, providing the annealed composition with a work function interface having a work function interface that is closer to the initial work function and that is not susceptible to substantial degradation in the ambient steady-state condition.

18. The method of claim 17, wherein the step of providing the composition includes providing the carbon-based structures being at least one of carbon nanotubes and graphene structures, and providing the oxide material being at least one of Tungsten oxide, Molybdenum oxide, vanadium oxide, nickel oxide, copper oxide, and rhenium oxides.

19. The method of claim 17, the annealing step includes applying heat at a temperature between 150 degrees C. and 1000 degrees C.

20. The method of claim 17, the step of providing the composition includes treating the carbon-based structures with the oxide material by applying the oxide material via at least one of thermal evaporation; sputtering; atomic layer deposition (ALD); and chemical vapor deposition (CVD).
